(19) United States
(12) Patent Application Publication
(10) Pub. No.: US 2006/0238725 A1
(43) Pub. Date: Oct. 26, 2006

(54) Projection apparatus provided with a modular device

(75) Inventors: Tung-Hua Chou, Miao Li County (TW); Hung-Lin Lee, Miao Li County (TW); Chih-Chung Yang, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/407,198

(22) Filed: Apr. 20, 2006

(30) Foreign Application Priority Data
Apr. 22, 2005 (TW) 94112915

(51) Int. Cl. G03B 21/22

(52) U.S. Cl. 353/119

(57) ABSTRACT

A projection apparatus includes a casing having a first surface, a modular device having a second surface, and a tongue member complementing with the first surface and protruding outwardly from the second surface. The tongue member has an approximate section and a distal section with a cross-section greater than a cross-section of the approximate section. A U-shaped resilient member has a lower portion fixed securely on the first surface of the casing, and an upper portion defining an entrance with a width smaller than a width of the distal section of the tongue member. The distal section of the tongue member is inserted into the U-shaped resilient member via the entrance so as to mount the second surface of the modular device on the first surface of the casing.

### FIELD OF THE INVENTION

The invention relates to a projection apparatus, and more particularly to a projection apparatus provided with a modular device.

### BACKGROUND OF THE INVENTION

Referring to FIG. 1, a conventional projector 2 is connected to a peripheral device 4, which transmits an image to the projector 2 so that the projector 2 can project the image onto a screen in a relatively large dimension.

As illustrated, the peripheral device 4 transmits the image to the projector 2, which projects the image onto the screen. The peripheral device 4 can be an optical disk drive as shown in FIG. 1 and is coupled to the conventional projector 2 via a connecting cable 6.

In addition, the conventional projector 2 can also be coupled to the other electronic devices, such as a TV set or an audio-and-video system. Since the peripheral device 4 is formed separately from the conventional projector 2, a connecting cable 6 must be employed in order to couple the conventional projector 2 and the peripheral device 4 electrically. The presence of the connecting cable 6 at the exterior of the projector 2 decreases an aesthetic appearance of the conventional projector 2 in addition to causing hindrance during the transport.

### SUMMARY OF THE INVENTION

It is the object of the present invention to provide a projection apparatus having a modular device that is coupled to a casing in such a manner to increase an aesthetic appearance of the projection apparatus and that permits easy attachment and detachment of a peripheral device to the casing. Once the peripheral device is attached to the casing, the whole projection apparatus has a relatively small size so as to convenient in transport and storage.

In one aspect of the present invention, a projection apparatus is provided to include a casing having a first surface, a modular device having a second surface complementing with the first surface of the casing, and a tongue member protruding outwardly from the second surface. The tongue member has an approximate section and a distal section. The distal section has a cross-section greater than a cross-section of the approximate section. The U-shaped resilient member has a lower portion fixed to the first surface of the casing, and an upper portion defining an entrance with a width smaller than that of the distal section of the tongue member. The distal section of the tongue member is inserted into the U-shaped resilient member so as to mount the second surface of the modular device on the first surface of the casing.

In a second aspect of the present invention, a projection apparatus is provided to include a casing having a first surface formed with a first connector, and a modular device having a second surface complementing with the first surface of the casing, the second surface being formed with a second connector, wherein the modular device is selected from an audio-and-video system including an optical disk drive and a recording and reproducing instrument. Mounting the second surface of the modular device onto the first surface of the casing results in an electrical coupling of the first and second connectors.

In a third aspect of the present invention, a projection apparatus is provided to include a casing having a first surface, a modular device having a second surface complementing with the first surface of the casing, and a coupling device interposed between the first and second surfaces, and including a U-shaped resilient member fixed to one of the first and second surfaces and a tongue member fixed to the other one of the first and second surfaces such that insertion of the tongue member into the U-shaped resilient member results in mounting of the second surface of the modular device onto the first surface of the casing.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a schematic side view of a conventional projector connected to a peripheral device;

FIG. 2A is an exploded view of a projection apparatus of the present invention;

FIG. 2B is an enlarged view of a portion of FIG. 2A; and

FIG. 3 is a cross-sectional view of a modular device interconnected to a casing of the projection apparatus of the present invention.

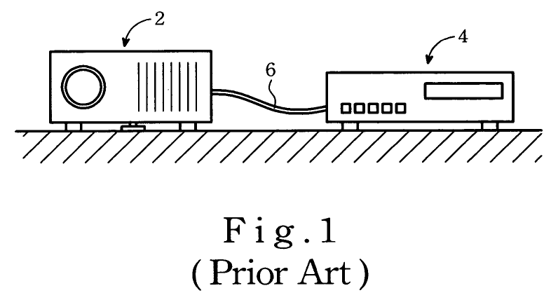

### DETAILED DESCRIPTIONS OF THE PREFERRED EMBODIMENT

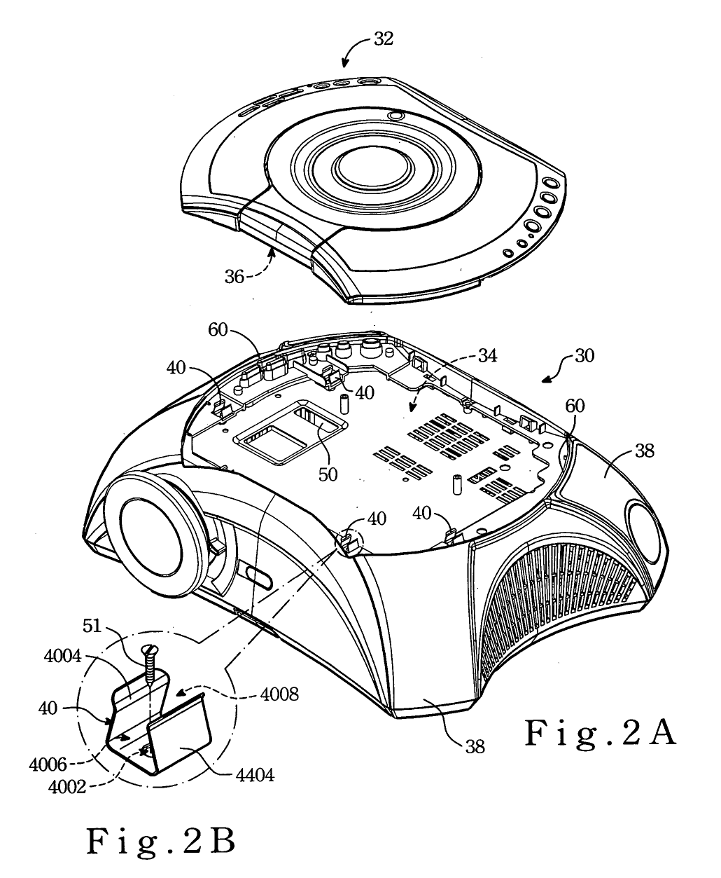

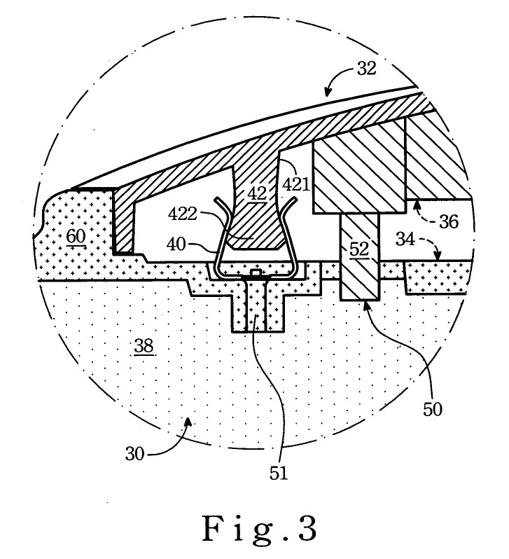

Referring to FIGS. 2A, 2B, and 3, a projection apparatus 30 of the present invention is shown and includes a casing 38, a modular device 32, a projection module (not shown) and a coupling device including at least one U-shaped resilient member 40 (preferably 4) and tongue members 42.

The casing 38 has a first surface 34. The projection module is installed in the casing 38. The projection module includes a light source, a light valve and a projection lens, for example.

The modular device 32 has a second surface 36 complementing with the first surface 34 of the casing 38. Each tongue member 42 protrudes outwardly from the second surface 36, and has an approximate section 421 and a distal section 422. The distal section 422 has a cross-section greater than a cross-section of the approximate section 421. Preferably, the modular device 32 is selected from an audio-and-video system including an optical disk drive and a recording and reproducing instrument. Thus, in case the disk drive serves as the modular device 32, it is capable of providing an image data to the projection module. The projection module is used for transferring image data into an image, and projecting the image on a screen (not shown) disposed away from the casing 38.

The U-shaped resilient member 40 is mounted on the first surface 34 of the casing 38. Each resilient member 40 has a lower portion 4006 fixed to the first surface 34 of the casing 38, and an upper portion defining an entrance 4008 (see FIG. 2B) with a width smaller than a width of the distal section 422 of the tongue member 42. As shown in FIG. 3, insertion of the distal sections 422 of the tongue member 42 into the U-shaped resilient members 40 respectively via the entrances 4008 results in a mounting of the second surface 36 of the modular device 32 onto the first surface 34 of the casing 38. Preferably, the lower portion 4006 of a respective resilient member 40 is formed with a screw hole 4002. A fastener screw 51 extends through the screw hole 4002 in the lower portion 4006 of the U-shaped resilient member 40 in order to mount the resilient member 40 onto the first surface 34 of the casing 38.

In this embodiment, each of the resilient members 40 is made from a resilient metal, and has left and right lateral portions 4004 extending from two opposite ends of the lower portion 4006 to form the upper portion of the respective resilient member 40.

In this embodiment, seating the second surface 36 of the modular device 32 onto the first surface 34 of the casing 38 results in insertion of the tongue member 42 into the U-shaped resilient members 40, thereby coupling the modular device 32 and the casing 30 together.

Alternately, each of the resilient members 40 can be fixed to the second surface 36 of the modular device 32 while the tongue member 42 is fixed to the first surface 34 of the casing 30. Under this condition, seating the second surface 36 of the modular device 32 onto the first surface 34 of the casing 38 results in the insertion of the tongue member 42 of the first surface 34 into the U-shaped resilient members 40 of the second surface 36 to couple the modular device 32 and the casing 30 together.

Referring again to FIG. 2A, the first surface 34 of the casing 38 is formed with a first connector 50. The second surface 36 the modular device 32 is formed with a second connector 52, whereby when the modular device 32 is mounted onto the casing 38, the first and second connectors 50, 52 are coupled together electrically. The first connector 50 can be a plughole while the second connector 52 can be a plug member that extends into and engages the plughole once the modular device 32 is mounted onto the casing 38.

Referring to FIG. 2A, the casing 38 has an upper. section formed with an upper recess. The upper recess is defined by a recess-confining wall having a bottom wall portion and a peripheral wall portion 60 extending upwardly from the bottom wall portion to define the first surface 34 of the casing 38. The second surface 36 of the modular device 32 has a configuration to complement with the peripheral wall portion 60 of the upper recess in the casing 38 in such a manner that after insertion of the section 422 of the tongue member 42 into the U-shaped resilient member 40 via the entrance 4008, the second surface 36 of the modular device 32 is seated in the peripheral wall portion 60 of the upper recess in the casing 38.

Note that the tongue members 40 are mounted on the second surface 36 of the modular device 32 while the resilient members 42 are mounted on the first surface of the casing 38. Alternately, the tongue members 40 can be mounted on the first surface of the casing while the resilient members can be mounted on the second wall of the modular device 32 (not shown).

To summarize the above paragraphs, it is observable that since the modular device 32 for providing an image is mounted on the casing in a neat-and-tidy manner, the projection apparatus of the present invention is compact in size and therefore is facilitate to be carried along with the user.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A projection apparatus comprising:
a casing having a first surface;
a projection module installed in said casing;
a modular device having a second surface complementing with said first surface of said casing and a tongue member protruding outwardly from said second surface, said tongue member having a distal section and an approximate section, said distal section having a cross-section greater than a cross-section of said approximate section; and
a U-shaped resilient member having a lower portion fixed to said first surface of said casing, and an upper portion defining an entrance with a width smaller than a width of said distal section of said tongue member, an insertion of said distal section of said tongue member into said U-shaped resilient member via said entrance resulting in mounting of said second surface of said modular device onto said first surface of said casing.

2. The projection apparatus according to claim 1, wherein said lower portion of said U-shaped resilient member is formed with a screw hole, the projection apparatus further comprising a fastener screw extending through said screw hole in said, lower portion of said U-shaped resilient member in order to mount said resilient member onto said first surface of said casing.

3. The projection apparatus according to claim 1, wherein said resilient member further has left and right lateral portions extending from two opposite ends of said lower portion to form said upper portion of said resilient member.

4. The projection apparatus according to claim 1, wherein said resilient member is made from metal.

5. The projection apparatus according to claim 1, wherein f said modular device capable of providing an image data to said projection module, and said projection module is used for transferring said image data into an image and projecting said image on a screen disposed away from said casing.

6. The projection apparatus according to claim 1, wherein said first surface of said casing is formed with a first connector, said second surface said modular device being formed with a second connector, whereby when said modular device is mounted onto said casing, said first and second connectors are coupled together electrically.

7. The projection apparatus according to claim 1, wherein said modular device is selected from an audio-and-video system including an optical disk drive and a recording and reproducing instrument.

8. The projection apparatus according to claim 1, wherein said casing has an upper recess, said upper recess being defined by a recess-confining wall having a bottom wall portion and a peripheral wall portion extending upwardly from said bottom wall portion to define said first surface, said second surface of said modular device complementing with said peripheral wall portion of said upper recess in said casing in such a manner to permit insertion of said distal section of said tongue member into said U-shaped resilient member via said entrance.

9. The projection apparatus according to claim 8, wherein said casing has an upper section formed with said upper recess, said modular device having a bottom section formed with said second surface.

10. A projection apparatus comprising:
a casing having a first surface formed with a first connector;
a projection module installed in said casing; and
a modular device having a second surface complementing with said first surface of said casing, said second surface being formed with a second connector, wherein said modular device is selected from an audio-and-video system including an optical disk drive and a recording and reproducing instrument, and wherein mounting said second surface of said modular device onto said first surface of said casing results in electrical coupling of said first and second connectors.

11. The projection apparatus according to claim 10, wherein said modular device further has a tongue member projecting outwardly from said second surface, wherein said tongue member has an approximate section and a distal section, said distal section having a cross-section greater than a cross section of said approximate section, the projection apparatus further comprising a U-shaped resilient member having a lower portion fixed to said first surface of said casing, and an upper portion defining an entrance with a width smaller than a width of said distal section of said tongue member, whereby, insertion of said distal section of said tongue member into said U-shaped resilient member via said entrance results in mounting of said second surface of said modular device onto said first surface of said casing.

12. The projection apparatus according to claim 11, further comprising a coupling device interposed between said casing and said modular device.

13. The projection apparatus according to claim 12, wherein said tongue member and said U-shaped resilient member cooperatively define said coupling device.

14. The projection apparatus according to claim 10, wherein said casing has an upper section formed with said first surface, said modular device having a bottom section formed with said second surface.

15. The projection apparatus according to claim 10, wherein said casing has an upper section formed with an upper recess, said upper recess being defined by a recess-confining wall having a bottom wall portion and a peripheral wall portion extending upwardly from said bottom wall portion to define said first surface, said second surface of said modular device complementing with said peripheral wall portion of said upper recess in said casing in such a manner to be seated within said upper recess in said casing.

16. A projection apparatus comprising:
a casing having a first surface;
a projection module installed in said casing;
a modular device having a second surface complementing with said first surface of said casing; and
a coupling device interposed between said first and second surfaces and including a U-shaped resilient member fixed to one of said first and second surfaces, and a tongue member fixed to the other one of said first and second surfaces, insertion of said tongue member into said U-shaped resilient member resulting in mounting of said second surface of said modular device onto said first surface of said casing.

17. The projection apparatus according to claim 16, wherein said tongue member has an approximate section and a distal section, said distal section having a cross-section greater a cross section of said approximate section.

18. The projection apparatus according to claim 16, wherein said tongue member extends outwardly from said first surface of said casing, said U-shaped resilient member being fixed to said second surface of said modular device.

19. The projection apparatus according to claim 16, wherein said tongue member extends outwardly from said second surface of said modular device, said U-shaped resilient member being fixed to said first surface of said casing.

20. The projection apparatus according to claim 16, wherein said casing has an upper section formed with an upper recess, said upper recess being defined by a recess-confining wall having a bottom wall portion and a peripheral wall portion extending upwardly from said bottom wall portion to define said first surface, said second surface of said modular device complementing with said peripheral wall portion of said upper recess in said casing in such a manner to be seated within said upper recess in said casing.
